(19) United States
(12) Patent Application Publication
(10) Pub. No.: US 2014/0218416 A1
(43) Pub. Date: Aug. 7, 2014

(54) DISPLAY APPARATUS AND CONTROL METHOD THEREOF

(71) Applicant: CANON KABUSHIKI KAISHA, Tokyo (JP)

(72) Inventors: Yasuo Suzuki, Yokohama-shi (JP); Joji Kamahara, Tokyo (JP)

(21) Appl. No.: 14/172,558

(22) Filed: Feb. 4, 2014

(30) Foreign Application Priority Data
Feb. 7, 2013 (JP) 2013-022397

(51) Int. Cl. G09G 5/10

(52) U.S. Cl. CPC G09G 5/10
USPC 345/690

(57) ABSTRACT

A display unit displays an image. A light emission unit emits light to the display unit. A control unit controls the light emission brightness of the light emission unit. A gradation correction unit executes a gradation correction processing to the image to be displayed by the display unit based on the light emission brightness of the light emission unit.

### BACKGROUND

1. Field

The present disclosure relates to an apparatus and method for displaying an image.

2. Description of the Related Art

Some automatic brightness control technology exists, which increases the brightness of image data if the brightness of an image is too dark and decreases the brightness of image data if the brightness of an image is too bright.

For example, International Patent Application Publication No. WO2004/008755 discloses retrieving shooting information stored in an image file, determining photometry scheme of shooting, and executing image processing on the image data depending on the photometry scheme. Automatic brightness control is executed if the photometry scheme of shooting is the spectro-photometry scheme. Automatic brightness control is not executed if the photometry scheme of shooting is the spot-photometry scheme. Therefore, automatic brightness control is not executed if an exposure value for shooting is set to a subject corresponding to a spot area.

Japanese Laid-open Patent Publication No. 2007-067907 discloses that image quality adjustment by gradation correction is suppressed if ISO sensitivity is high, because noise ingredient is easy to generate. The external light amount is calculated from a shutter speed or an aperture value, and the smaller the external light amount, the smaller the gradation correction amount that is applied. The gradation correction amount is decreased if the shooting mode is the night shooting mode, and the gradation correction amount is increased if the shooting mode is the portrait shooting mode.

In a liquid crystal display apparatus, a light emission unit (a backlight module) is provided behind the liquid crystal display panel. In an organic EL (Electro Luminescence) display panel, the organic EL display panel itself operates as the self-emitting type light emission unit. It may be considered preferable to control the light emission of the display apparatus depending on the brightness of the external light (environmental light) during shooting in order to realize image display which is close to the impression of the subject during shooting.

However, the above references execute image processing to the image data adaptively, by using only shooting information. Thus, in some cases, image display which is close to the impression of the subject during shooting is not realized because the light emission brightness of the light emission unit of the display apparatus is not controlled appropriately.

For example, when the display apparatus displays an image which was shot at a place where the external light was too bright or too dark, the subject may not be displayed with enough brightness if the light emission brightness of the light emission unit is fixed. Particularly when the display apparatus displays an image including a face of a subject photographed darkly because of the backlight, or an image including a subject photographed darkly because of inappropriate exposure control, the subject may not be displayed with enough brightness if the light emission brightness of the light emission unit is a fixed value.

Also, when the display apparatus displays an image shot with high ISO sensitivity at a place where the external light was dark, noise ingredient of the image may be highly visible if the light emission brightness of the light emission unit is fixed.

There are some display apparatus which control the light emission brightness depending on image characteristics such as brightness of the image data. But, in some cases, image display which is close to the impression of the subject during shooting is not realized because the light emission brightness of the light emission unit of the display apparatus is not controlled appropriately depending on the brightness of the external light during shooting. For example, when the display apparatus displays an image including a subject darkly photographed at a place where the external light was bright because of inappropriate exposure control, the subject may not be displayed with enough brightness if the light emission brightness of the light emission unit is decreased depending on the darkness of the image data. When the display apparatus displays an image shot with high ISO sensitivity at a place where the external light was dark, noise ingredient of the image may be highly visible if the light emission brightness of the light emission unit is increased depending on the brightness of the image data.

The present subject matter provides a display apparatus and a control method thereof that is capable of displaying an image close to the impression of the subject during shooting.

### SUMMARY

According to one aspect of the present subject matter, a display apparatus includes a display unit configured to display an image, a light emission unit configured to emit light to the display unit, a control unit configured to control the light emission brightness of the light emission unit, and a gradation correction unit configured to execute a gradation correction processing to the image to be displayed by the display unit based on the light emission brightness of the light emission unit.

According to another aspect of the present subject matter, a display apparatus includes a self-emitting type display unit configured to display an image, an obtaining unit configured to obtain shooting information relating to a shooting condition during shooting of the image, and a control unit configured to control the light emission peak brightness of the light display unit based on the shooting information.

Further features of the present subject matter will become apparent from the following description of exemplary embodiments (with reference to the attached drawings).

### BRIEF DESCRIPTION OF THE DRAWINGS

FIG. 1 is an example block diagram of a display apparatus according to a first embodiment.

FIG. 2A depicts an example data structure of an image file.

FIG. 2B depicts an example of data in a header section of the image file of FIG. 2A.

FIG. 3 depicts, conceptually, an example procedure of adding external light level information as shooting information to an image file.

FIG. 4 depicts an example of conversion processing from n×m pixels image data to a raster scan format image signal.

FIG. 5 is an example flow chart of a determination processing of the light emission brightness.

FIG. 6 depicts an example relation between external light level and light emission brightness.

FIG. 7 depicts an example relation between aperture value and external light level.

FIG. 8 depicts an example relation between PWM value and light emission brightness.

FIG. 9 depicts example gamma correction curves 1-9 used by a gradation correction unit.

FIG. 10 depicts an example relation between light emission brightness(es) (minimum/middle/maximum) and applied gamma correction curve(s).

FIG. 11 depicts an example of the light emission brightness(es) determined depending on how the external light level is restricted with an upper limit and a lower limit.

FIG. 12 depicts an example of determination processing of the light emission brightness according to an alternative of the first embodiment.

FIG. 13 depicts an example relation between shooting mode and external light level.

FIG. 14 is an example block diagram of a display apparatus according to a second embodiment.

FIG. 15 is an example flow chart of a determination processing of light emission brightness according to the second embodiment.

FIG. 16A depicts an example relation between an image characteristic amount and light emission brightness.

FIG. 16B depicts an example relation between external light level and an adjusting amount of light emission brightness.

FIG. 17 is an example block diagram of a display apparatus according to a third embodiment.

FIG. 18 depicts an example relation between external light level and light emission peak brightness.

### DETAILED DESCRIPTION

### First Embodiment

The first embodiment is explained with diagrams as follows.

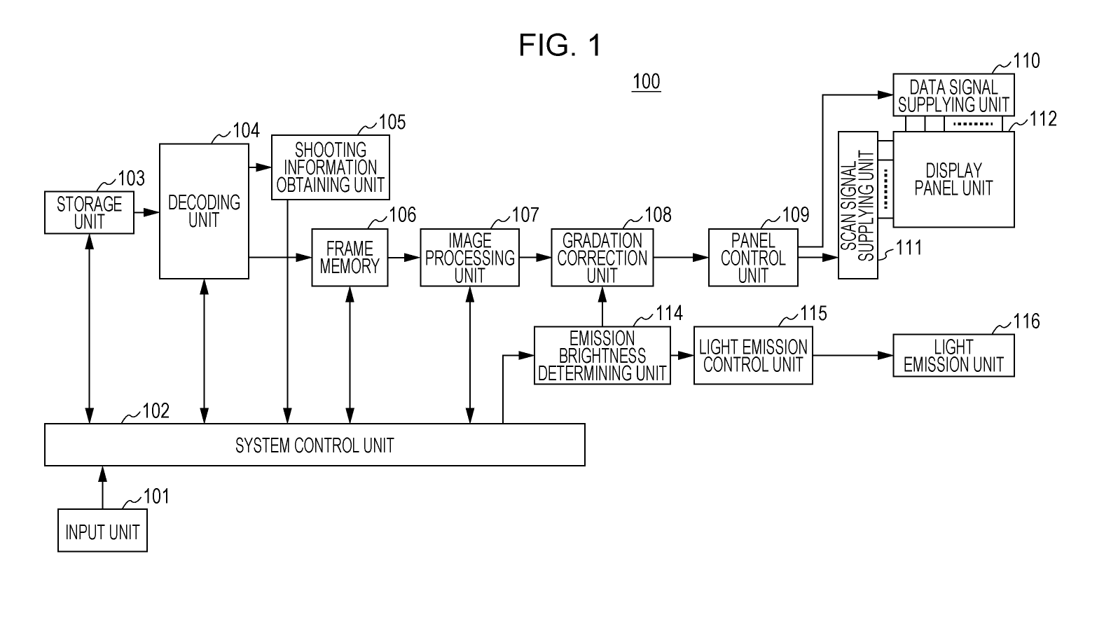

FIG. 1 is an example block diagram that depicts a display apparatus 100 according to the first embodiment. The display apparatus 100 comprises an input unit 101, a system control unit 102, a storage unit 103, a decoding unit 104, a shooting information obtaining unit 105, a frame memory 106, an image processing unit 107, a gradation correction unit 108, a panel control unit 109, a data signal supplying unit 110, a scan signal supplying unit 111, and a display panel unit 112. The display apparatus 100 further comprises an emission brightness determining unit 114, a light emission control unit 115, and a light emission unit 116. The light emission unit 116 (such as a backlight module) is a surface emission device emitting light from behind and toward the display panel unit 112. As an example display panel, an example liquid crystal display panel of which the light transmittance is controllable for each pixel depending on displayed images is described below. A light emission unit with mounted LED (Light-Emitting Diode) elements is described below. However, the display panel and the light emission unit are not limited to such devices. For example, a light emission unit with mounted organic EL (Electro Luminescence) elements may alternatively be used. Alternatively, a display panel comprising elements which can control the light transmittance from the light emission unit except for liquid crystal elements may be used. A liquid crystal projector for projecting images on a screen can also alternatively be applied to the display apparatus.

An image file such as a still image file, a moving image file, or an image data decoded by an external apparatus (not illustrated) is inputted to the input unit 101 from the external apparatus. The system control unit 102 such as a Central Processing Unit (CPU) controls each function block in the display apparatus 100. Specifically, the system control unit 102 retrieves a computer program from a nonvolatile memory (ROM, etc.) to execute various operations.

If an image file is inputted to the input unit 101, the system control unit 102 stores the inputted image file into the storage unit 103. The decoding unit 104 retrieves the image file stored in the storage unit 103, decodes the retrieved image file, separates shooting information and the image data, and outputs the separated shooting information and the image data. The shooting information obtaining unit 105 obtains the shooting information outputted from the decoding unit 104, and outputs the obtained shooting information to the system control unit 102. The frame memory 106 accumulates image frames of the image data outputted from the decoding unit 104.

If the image data decoded by the external apparatus is inputted to the input unit 101, the system control unit 102 outputs the inputted image data to the frame memory 106. If the shooting information corresponding to the image data is inputted to the input unit 101, system control unit 102 outputs the inputted shooting information to the shooting information obtaining unit 105. Thus, the shooting information obtaining unit 105 obtains the shooting information corresponding to the image data from the decoding unit 104 or the system control unit 102.

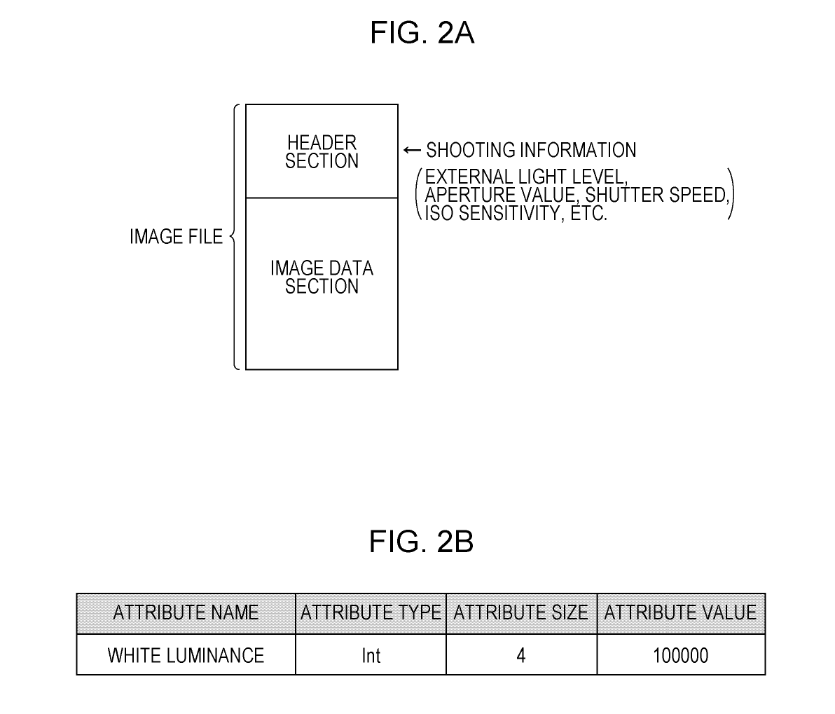

FIG. 2A depicts an example data structure of an image file. The image file such as the still image file or the moving image file comprises a header section and an image data section. Shooting information (external light level, aperture value, shutter speed, ISO sensitivity, shooting mode, etc.) relating to a shooting condition during shooting of the image is stored in the header section. RGB values for each pixel included in the image is stored in the image data section. Thus, the shooting information relating to the shooting condition during shooting of the image is generally added to the shot image data by a camera. As a data format of the image file, OpenEXR, Tagged Image File Format (TIFF), Joint Photographic Experts Group (JPEG), Moving Picture Experts Group (MPEG), Audio Video Interleave (AVI), etc. are used.

FIG. 2B is an example depiction of data in a header section of the OpenEXR format. The header section includes data such as attribute name, attribute type, attribute size, and attribute value.

The attribute name represents the type of the shooting information. Information indicating the external light (environmental light) brightness during shooting is described in ASCII code “white luminance”. The attribute type represents the data format of the attribute value. If the data format is integer format, “int” is described as the attribute type. The attribute size represents data size (byte) of the attribute value. The attribute value represents values of the shooting information (external light level, aperture value, shutter speed, ISO sensitivity, etc.)

OpenEXR format is used for high-dynamic-range (HDR) image file. In particular, OpenEXR format is generally used in the computer graphics (CG) industry. Academy Color Encoding Specification (ACES) format is compatible with OpenEXR format.

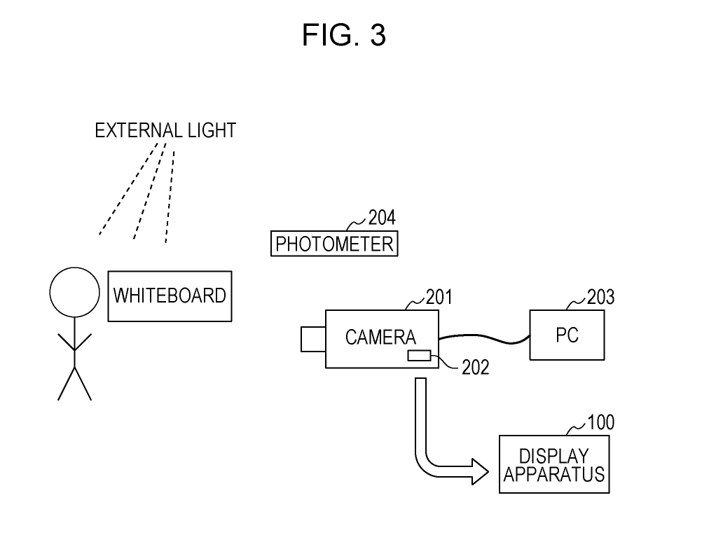

FIG. 3 depicts, conceptually, an example procedure for adding external light level information as shooting information to the image file. A camera 201 shoots a subject, generates a still image or a moving image, and records the shot image data to a removable media 202 in the camera 201. When the camera 201 shoots the subject (during shooting or after the shooting), the photographer or the assistant measures the external light level by using a photometer 204. Specifically, they place a whiteboard in order to reflect light to the subject, and measure the reflected light as the external light. They input the measured value to a personal computer (PC) 203 connected with the camera 201, and then the measured value is recorded in the header section of the shot image file. For example, “lux” is used as a unit of the measured value. The image file recorded in the removable media 202 is inputted to the display apparatus 100 by inserting the removable media 202 which was inserted in the camera 201 into the display apparatus 100. Alternatively, the image file may be inputted to the display apparatus 100 directly from the removable media 202 inserted in the camera 201 through a USB cable and/or other devices or technology which connects the camera 201 and the display apparatus 100. If the camera 201 does not have a recording function, the image file may be recorded to the removable media 202 in a recorder by connecting the camera 201 and the recorder and the PC 203. For example, a flash memory or a SD card may be used as the removable media 202.

If the camera 201 shoots a moving image, they may measure the external light lever for each scene (one scene includes a plurality of image frames) and store the measured value for each scene in the header section of the image file. If the photometer 204 is connected to the camera 201, the photometer 204 connected to the camera 201 may automatically measure the external light level during shooting, then the measured value is transported from the photometer 204 to the camera 201 and automatically stored in the header section of the image file. If the camera 201 does not have a recording function, the measured value may be transported from the photometer 204 to the recorder though the camera 201, then the measured value may be automatically stored in the header of the image file. A stream format image data may be inputted from the camera 201 (or the recorder or a player) to the display apparatus 100. For example, an unprocessed data format, such as a RAW format moving image data shot by the camera 201 may be inputted to the display apparatus 100 in real-time. A moving image data decoded by the camera 201 may be inputted to the display apparatus 100. In that case, shooting information indicating the external light level during shooting may be inputted to the display apparatus 100 from the camera 201 (or the recorder or the player, etc.), PC 203, or photometer 204.

With reference to FIG. 1, the shooting information obtaining unit 105 analyzes the obtained shooting information (external light level, aperture value, shutter speed, ISO sensitivity, shooting mode, etc.). For example, if the OpenEXR format is used, the attribute value corresponding to the attribute name “white luminance” is extracted as the external light level information; aperture value information, shutter speed information, ISO sensitivity information, and shooting mode information are extracted by referring the attribute name and the attribute value. The extracted various information are outputted from the shooting information obtaining unit 105 to the system control unit 102.

The image processing unit 107 retrieves the image data from the frame memory 106 and converts the image data to the raster format image signal. The image processing unit 107 also executes various image processing (such as interlace-progressive conversion processing, enlargement and reduction processing, edge enhancement processing, gain adjustment, offset adjustment, color adjustment, limiting processing, etc.) to the raster format image signal. Then the image processing unit 107 converts the image signal from the raster format to a data format appropriate for the display panel unit 112. For example, a first bit number of the image signal may be converted to a second bit number appropriate for the display panel unit 112.

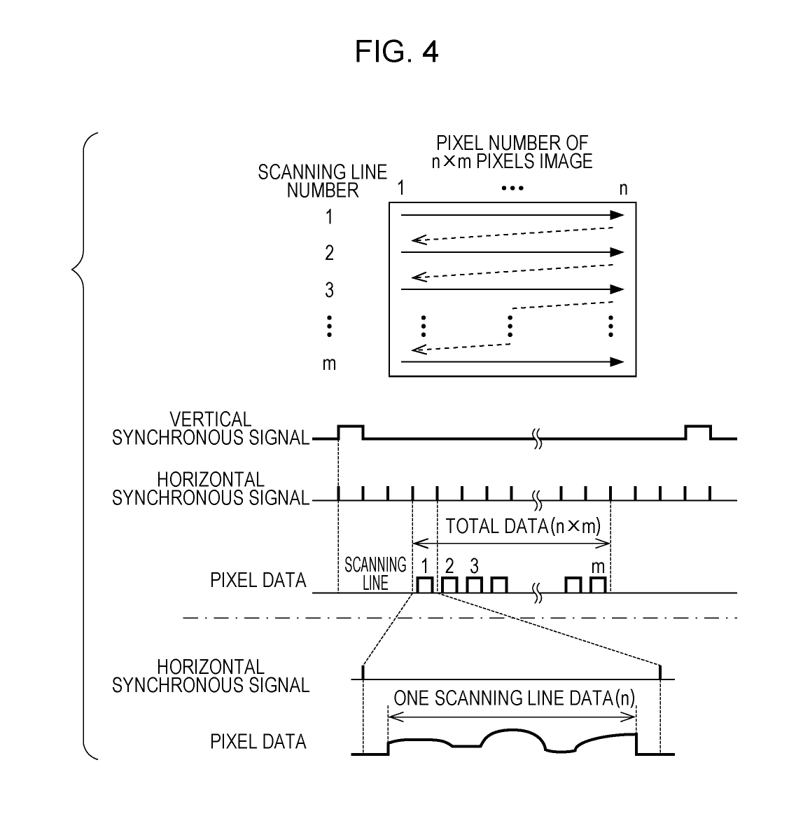

FIG. 4 is an example depiction of a conversion processing from n×m pixels image data to a raster scan format image signal. The raster scan format image signal includes a pixel data stream generated by scanning the image from the first scanning line to m-th scanning line. The image processing unit 107 adds a vertical synchronous signal indicating a start point of each image frame and a horizontal synchronous signal indicating a start point of each scanning line to the image signal, and outputs the image signal.

The gradation correction unit 108 executes the gradation correction processing to the image signal output from the image processing unit 107 based on the light emission brightness of the light emission unit 116, which is determined by the emission brightness determining unit 114, and outputs the image signal to the panel control unit 109. The gradation correction processing by the gradation correction unit 108 will hereinafter be described in detail. The gradation correction unit 108 also outputs the vertical synchronous signal and the horizontal synchronous signal inputted from the image processing unit 107 to the panel control unit 109.

The display panel unit 112 is a liquid crystal panel comprising liquid crystal pixels arranged in matrix state. A scanning line arranged in a horizontal direction and a data line arranged in a vertical direction are both connected to each pixel. The transmittance of the liquid crystals of each line is controlled by selecting one scanning line and supplying data of the scanning line from the data line.

The panel control unit 109 generates a scan signal and a line data signal based on the image signal, the vertical synchronous signal, and the horizontal synchronous signal outputted from the gradation correction unit 108. The scan signal is used for selecting each scanning line of the display panel unit 112 from the top to the bottom. The line data signal is used for the image data to the scanning line selected by the scan signal. The scan signal supplying unit 111 selects each scanning line of the display panel unit 112 sequentially based on the scan signal from the panel control unit 109. The data signal supplying unit 110 supplies the image data to each scanning line of the display panel unit 112 based on the line data signal from the panel control unit 109.

The image processing unit 107 inserts an enable-period in a frame period. In the enable-period, the vertical synchronous signal has an enable state. The system control unit 102 receives the shooting information corresponding to each image frame or each scene from the shooting information obtaining unit, and outputs the received shooting information to the emission brightness determining unit 114 during the enable-period of the vertical synchronous signal. Thus, image display on the display panel unit 112 and light emission brightness control of the light emission unit 116 are synchronized with respect to each image frame or each scene.

The emission brightness determining unit 114 receives the shooting information from the shooting information obtaining unit 105, and determines the light emission brightness (light emission amount) of the light emission unit 116 based on the shooting information.

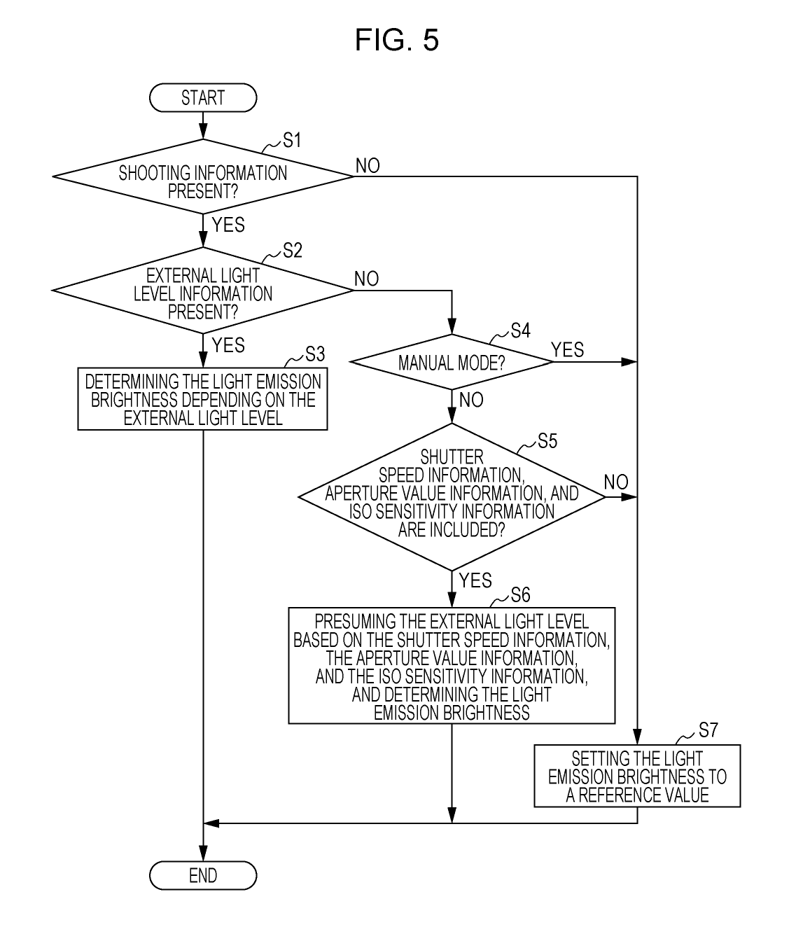

FIG. 5 is an example flow chart that depicts a determination processing of the light emission brightness by the emission brightness determining unit 114. This determination processing of the light emission brightness is executed at the beginning of image display. If the still image is displayed, the emission brightness determining unit 114 executes the determination processing of the light emission brightness before the still image is displayed. If the moving image is displayed, the emission brightness determining unit 114 executes the determination processing of the light emission brightness before the moving image is displayed, and also executes the determination processing of the light emission brightness with respect to each image frame or each scene during the moving image display.

In step S1, the emission brightness determining unit 114 determines whether shooting information corresponding to the image data to be displayed presents or not. If the shooting information is found, the operation proceeds from step S1 to step S2. If the shooting information is not found, the operation proceeds from step S1 to step S6.

In step S2, the emission brightness determining unit 114 determines whether external light level information is included in the found shooting information or not. If the external light level information is included in the found shooting information, the operation proceeds to step S3. In step S3, the emission brightness determining unit 114 refers to a previously stored table which indicates a relation between external light level and light emission brightness, and determines the light emission brightness of the light emission unit 116 based on the external light level information. The emission brightness determining unit 114 has a memory (not illustrated) that stores the table indicating the relation between the external light level and the light emission brightness.

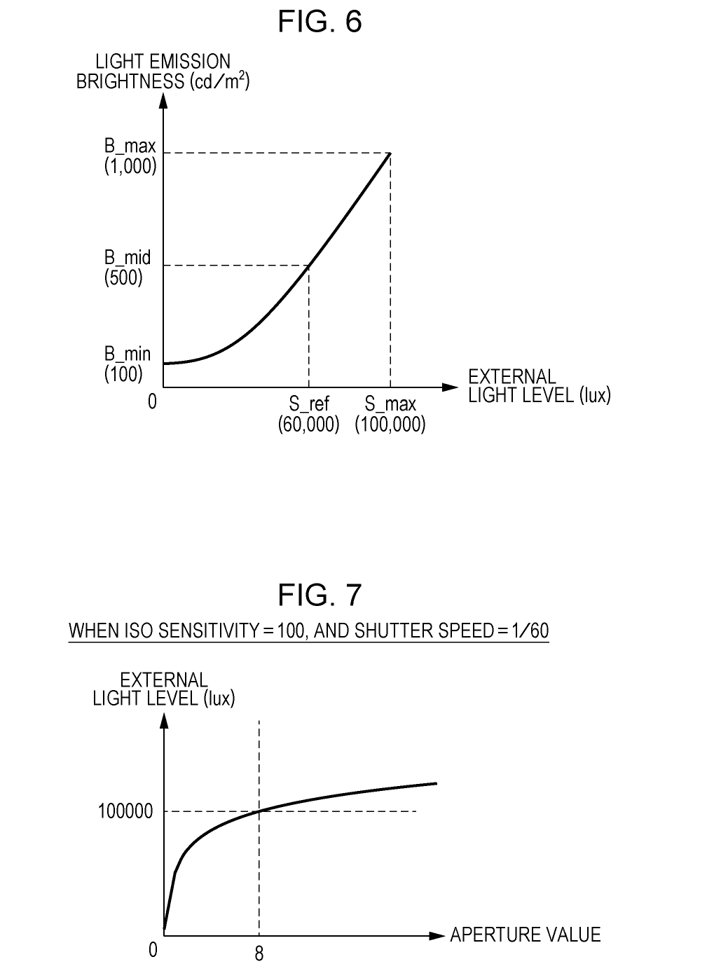

FIG. 6 is an example diagram of the relation between external light level and light emission brightness. In FIG. 6, the horizontal axis corresponds to external light level (lux), and the vertical axis corresponds to light emission brightness (cd/m²). As described above, “lux” is used as a unit of the luminance of the external light, and “cd/m²” is used as a unit of the light emission brightness. In order to realize an image display which is close to the impression of the subject during shooting, the light emission brightness is set higher than a reference value if the external light level is higher than a predetermined value, and the light emission brightness is set equal to or lower than the reference value if the external light level is equal to or lower than the predetermined value. Additionally, the higher the external light level is, the higher the light emission brightness is set. The lower the external light level is, the lower the light emission brightness is set.

Generally, the external light level is about 100,000 lux when it is fine weather. The external light level is about 10,000 lux when it is cloudy weather. The external light level is about 1,000 lux when a fluorescent lamp is used in a room. The external light level is about 100 lux under a streetlamp. The external light level is about 1 lux under moonlight. For example, a maximum value B max of the light emission brightness of the light emission unit 116 is set to 1,000 cd/m² corresponding to a maximum S_max value (for example, 100,000 lux) of the external light level. As another example, a medium value B_mid of the light emission brightness of the light emission unit 116 is set to 500 cd/m² corresponding to the reference value S_ref (for example, 60,000 lux) of the external light level. And as another example, a minimum value B_min of the light emission brightness of the light emission unit 116 is set to 100 cd/m² corresponding to the minimum value S_min (for example 0 lux) of the external light level. In this embodiment, the light emission brightness of the light emission unit 116 is set to the predetermined threshold B_min (>0) even if the external light level is 0. That is because some lights sometimes actually shine on the subject, and the subject may be photographed in the shot image depending on the circumstances, even though the external light level which is measured by the photometer 204 is 0. In that case, the subject becomes viewable in the displayed image of this embodiment.

Referring to FIG. 5, if the external light level information is not included in the found shooting information, the operation proceeds from step S2 to step S4. In step S4, the emission brightness determining unit 114 determines whether the image was shot with manual mode or auto mode based on the shooting information. Then, if the image was shot with auto mode, the operation proceeds to step S5, and the emission brightness determining unit 114 determines whether shutter speed information, aperture value information, and ISO sensitivity information are included in the shooting information or not. If those information are included in the shooting information, the operation proceeds to step S6, and the emission brightness determining unit 114 determines the light emission brightness of the light emission unit 116 based on the shutter speed information, the aperture value information, and the ISO sensitivity information. The determination processing in step S6 will hereinafter be described in detail. In this embodiment, the auto mode corresponds to a shooting mode in which the camera automatically set at least one of the shutter speed, aperture value, and ISO sensitivity.

The operation proceeds to step S7 if (a) the shooting information was not found in step S1, (b) if it was determined that the image was shot with manual mode in step S4, or (c) if it was determined that the shutter speed information, the aperture value information, and the ISO sensitivity information are not included in the shooting information in step S5. In step S7, the emission brightness determining unit 114 sets the light emission brightness of the light emission unit 116 to a predetermined reference value. The predetermined reference value may be set to the above described B_mid (500 cd/m²) or an arbitrary value such as 700 cd/m², etc. The user may be able to change the reference value arbitrarily.

Now, determination processing by the emission brightness determining unit 114 is described below in detail. The emission brightness determining unit 114 estimates the external light level during shooting based on the shutter speed information, the aperture value information, and the ISO sensitivity information. The external light level during shooting is estimated by a method similar to a method of calculating Exposure Value (EV) during shooting. If X=ISO sensitivity, Y=aperture value, and Z=shutter speed, then the value EV is calculated as the external light level during shooting by the following numerical formula (1).

EV=log₂(X/100)+2 log₂(Y)+log₂(Z) (1)

FIG. 7 is an example diagram that depicts a relation between aperture value and external light level when ISO sensitivity X=100 and shutter speed Z= 1/60. For example, if ISO sensitivity X=100, shutter speed Z= 1/60, and aperture value Y=8, then the value EV calculated by the numerical formula (1) becomes about 12. When the calculated value EV=12, the external light level is estimated to be 100,000 lux corresponding to fine weather. According to the numerical formula (1), it is estimated that the lower the ISO sensitivity is, the higher the external light level is. It is also estimated that the faster the shutter speed is, the higher the external light level is. In other words, it is estimated that the higher the ISO sensitivity is, the lower the external light level is. It is also estimated that the slower the shutter speed is, the lower the external light level is. There is a proportional relation between the calculated value EV and the external light level. For example, the external light level is estimated to be 50,000 lux if the calculated value EV=6, and the external light level is estimated to be 25,000 lux if the calculated value EV=3.

Thus, the emission brightness determining unit 114 estimates the external light level during shooting by using the shutter speed information, the aperture value information, the ISO sensitivity information, and the numerical formula (1). Then, the emission brightness determining unit 114 determines the light emission brightness of the light emission unit 116 by referring to the table which indicates the relation between external light level and light emission brightness. This subject matter is not limited to the example in which the light emission brightness of the light emission unit 116 is determined by using all of the shutter speed information, the aperture value information, and the ISO sensitivity information. The light emission brightness of the light emission unit 116 may be determined by using only one or two of the shutter speed information, the aperture value information, and the ISO sensitivity information. It is estimated that the lower the ISO sensitivity is, the higher the external light level is, and the higher the ISO sensitivity is, the lower the external light level is. It is estimated that the bigger the aperture value is, the higher the external light level is, and the smaller the aperture value is, the lower the external light level is. It is estimated that the faster the shutter speed is, the higher the external light level is, and the slower the shutter speed is, the lower the external light level is. Thus, the emission brightness determining unit 114 can determine the light emission brightness of the light emission unit 116 by using at least one of the shutter speed information, the aperture value information, and the ISO sensitivity information.

Referring to FIG. 1, the light emission unit 116 is a backlight module which is provided behind the display panel unit 112. Multiple light emission elements such as LEDs are mounted on a substrate of the light emission unit 116. The light emission control unit 115 generates a direct current control signal and PWM signal based on the light emission brightness determined by the emission brightness determining unit 114, and executes drive control of the light emission unit 116.

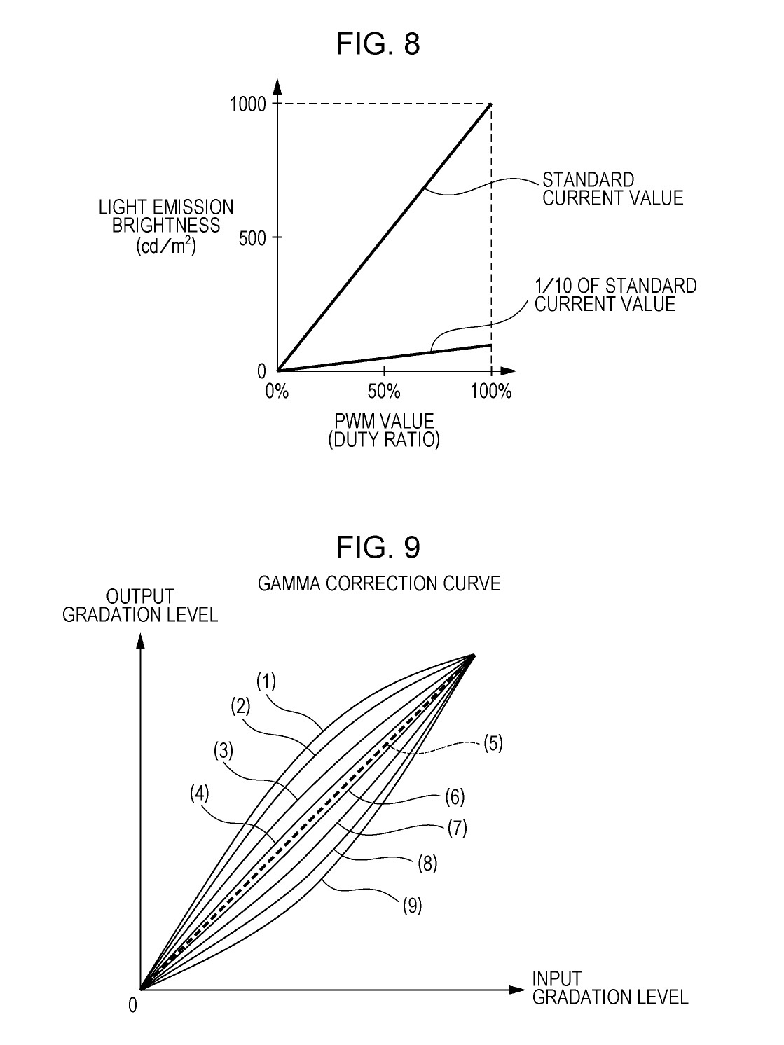

FIG. 8 is an example diagram that depicts a relation between the PWM value (duty ratio) and the external light level (cd/m²) when a LED is driven with a standard current value and 1/10 of the standard current value. The light emission brightness of the light emission unit 116 is determined by the current value for driving the LED of the light emission unit 116 and the ON-OFF duty ratio of the current. The light emission brightness can be controlled with wide dynamic range by controlling both of the current value and PWM value. For example, if the light emission brightness is determined to be 500 cd/m², the LED is driven with the standard current value and the ON-OFF duty ratio of the PWM signal is set to 50%.

Next, the gradation correction processing by the gradation correction unit 108 is described below. The gradation correction unit 108 executes the gradation correction processing to the image signal from the image processing unit 107 based on the light emission brightness of the light emission unit 116 determined by the emission brightness determining unit 114.

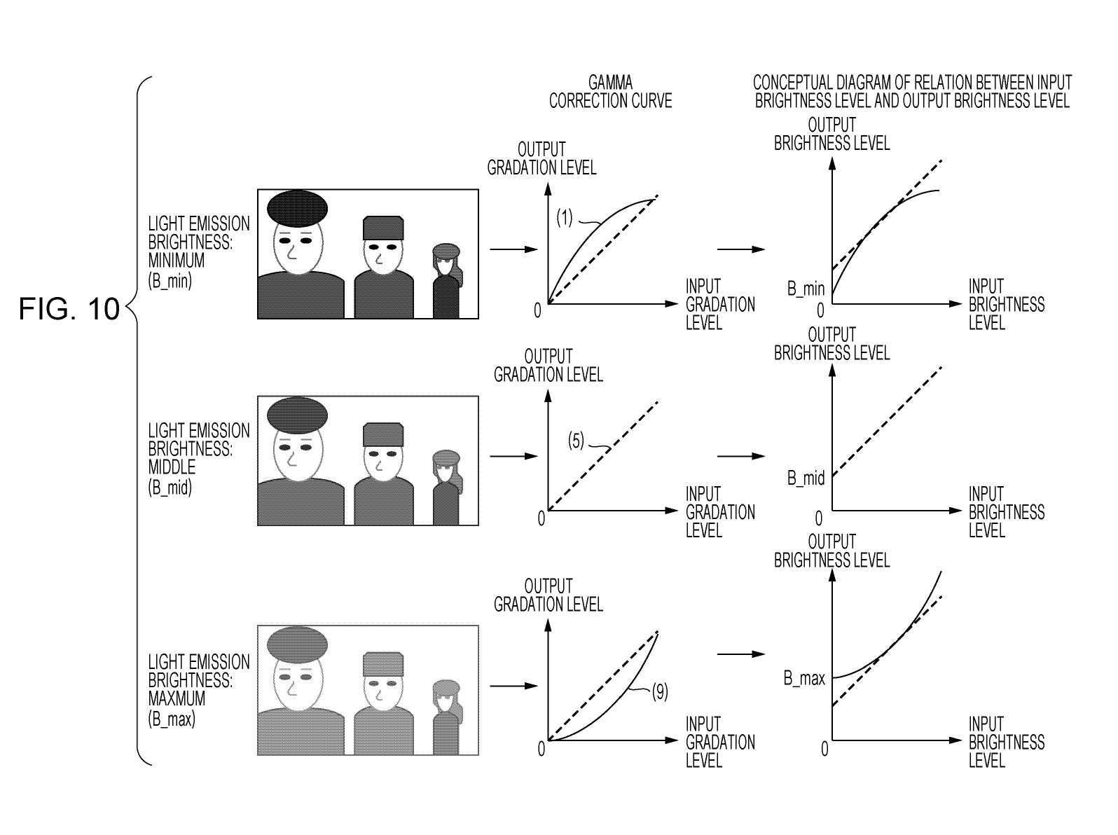

FIG. 9 is an example diagram that depicts gamma correction curves 1-9 used by the gradation correction unit 108. FIG. 10 depicts example relations between light emission levels (minimum/middle/maximum) and applied gamma correction curves. In FIG. 10, a conceptual diagram of the relation between input brightness level and output brightness level generated by merging the applied gamma correction curves and the light emission brightness (for each of minimum/middle/maximum) of the light emission unit 116 is also illustrated.

If the light emission brightness of the light emission unit 116 is lower than a predetermined value, the gradation correction unit 108 uses a gamma correction curve which improves a gradation characteristic (gradation reproducibility) of a low gradation (low brightness) component of the image, worsens a gradation characteristic of a high gradation (high brightness) component of the image, and raises a gradation level (brightness level) of a middle gradation (middle brightness) component of the image. Further, the lower the light emission brightness of the light emission unit 116 is, the more the gradation characteristic of the low gradation (low brightness) component of the image is improved. The lower the light emission brightness of the light emission unit 116 is, the more the gradation characteristic of the high gradation (high brightness) component of the image is worsened. Also, the lower the light emission brightness of the light emission unit 116 is, the more the gradation level of the middle gradation (middle brightness) component of the image is raised.

On the other hand, if the light emission brightness of the light emission unit 116 is equal to or higher than the predetermined value, a gamma correction curve which improves a gradation characteristic of a high gradation (high brightness) component of the image, worsens a gradation characteristic of a low gradation (low brightness) component of the image, and lowers a gradation level of a middle gradation (middle brightness) component of the image is used. Further, the higher the light emission brightness of the light emission unit 116 is, the more the gradation characteristic of the high gradation (high brightness) component of the image is improved. And, the higher the light emission brightness of the light emission unit 116 is, the more the gradation characteristic of the low gradation (low brightness) component of the image is worsened. And also, the higher the light emission brightness of the light emission unit 116 is, the more the gradation level of the middle gradation (middle brightness) component of the image is lowered.

Specifically, if the external light level is lower than the reference value S_ref (for example, 60,000 lux), the light emission brightness of the light emission unit 116 is set to a value lower than the middle value B_mid (for example, 500 cd/m²), and one of the gamma correction curves 1-4 is selected. For example, if the external light level is same as the minimum value S_min (for example, 0 lux), the light emission brightness of the light emission unit 116 is set to the minimum value B_min (for example, 100 cd/m²), and the gamma correction curve 1 is selected. If the external light level is low, it is preferable to improve the gradation characteristic (gradation reproducibility) of the low gradation (low brightness) components of the image as described above because the photographed subject is dark. And also, it is preferable to raise the gradation level (brightness level) of the middle gradation (middle brightness) components of the image as described above because the light emission brightness of the light emission unit 116 is set to a low value.

If the external light level is about the reference value S_ref (for example, 60,000 lux), the light emission brightness of the light emission unit 116 is set to the middle value B_mid (for example, 500 cd/m²), and the gamma correction curve 5 is selected. In that case, input gradation level and output gradation level are equal.

If the external light level is higher than the reference value S_ref (for example, 60,000 lux), the light emission brightness of the light emission unit 116 is set to a value higher than the middle value B_mid (for example, 500 cd/m²), and one of the gamma correction curves 6-9 is selected. For example, if the external light level is the same as the maximum value S_max (for example, 100,000 lux), the light emission brightness of the light emission unit 116 is set to the maximum value B max (for example, 1,000 cd/m²), and the gamma correction curve 9 is selected. If the external light level is high, it is preferable to improve the gradation characteristic (gradation reproducibility) of the high gradation (high brightness) components of the image as described above because the photographed subject is bright. It is also preferable to lower the gradation level (brightness level) of the middle gradation (middle brightness) components of the image as described above because the light emission brightness of the light emission unit 116 is set to a high value.

Therefore, according to this first embodiment, an image display which is close to the impression of the subject during shooting is realized by controlling the light emission brightness of the light emission unit of the display apparatus depending on the brightness of the external light (environmental light) during shooting. This embodiment may be especially effective for appreciating a professional still image or a professional moving image because the impression of the subject during shooting can be reproduced more faithfully, compared to the conventional technology.

The gradation correction processing by the gradation correction unit 108 is executed in this embodiment, but the gradation correction processing by the gradation correction unit 108 may be omitted. An image display which is close to the impression of the subject during shooting can be realized only by controlling the light emission brightness depending on the external light level. If the gradation correction processing by the gradation correction unit 108 is executed, an image display which is closer to the impression of the subject during shooting can be realized because the gradation reproducibility of the subject is improved.

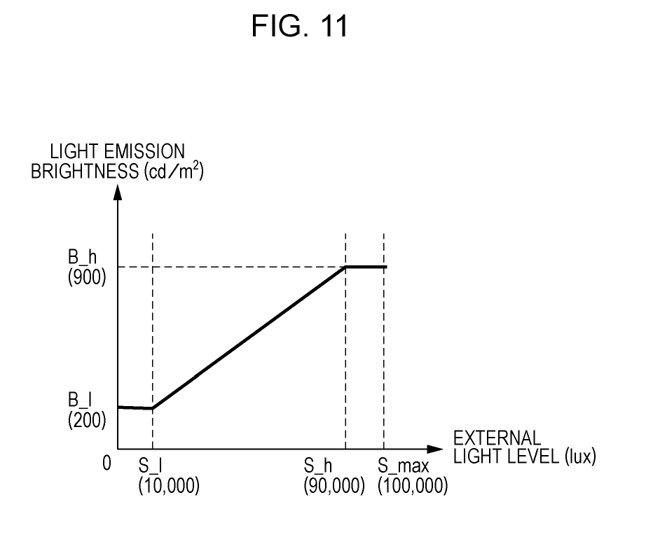

If the light emission brightness range of the light emission unit 116 is narrower than the light emission brightness range depicted in FIG. 6, the light emission brightness determined depending on the external light level may be restricted with an upper limit value and a lower limit value as depicted in FIG. 11. FIG. 11 depicts an example external light level range from 0 to S_max (for example, 100,000 lux), and the light emission brightness range is from B_l (for example, 200 cd/m²) to B_h (for example, 900 cd/m²). In FIG. 11, the light emission brightness of the light emission unit 116 corresponding to the external light level from the threshold S_h (for example, 90,000 lux) to the maximum value S_max (for example, 10,000 lux) is set to the upper limit B_h (for example, 900 cd/m²). The light emission brightness of the light emission unit 116 corresponding to the external light level from 0 to the threshold S_l (for example, 10,000 lux) is set to the lower limit B_l (for example, 200 cd/m²). Therefore, an appropriate light emission brightness can be determined even if the light emission brightness range of the light emission unit 116 is narrow.

### Modification of First Embodiment

In the above described first embodiment, in step S6 of FIG. 5, the emission brightness determining unit 114 determined the light emission brightness (light emission amount) of the light emission unit 116 based on the shooting information (shutter speed information, aperture value information, and ISO sensitivity information). In a modification of first embodiment, the emission brightness determining unit 114 determines the light emission brightness (light emission amount) of the light emission unit 116 based on the shooting mode. In this modification of the first embodiment, detailed descriptions of the contents similar to those discussed above with respect to the first embodiment will not be repeated, and only modified contents will be described in detail.

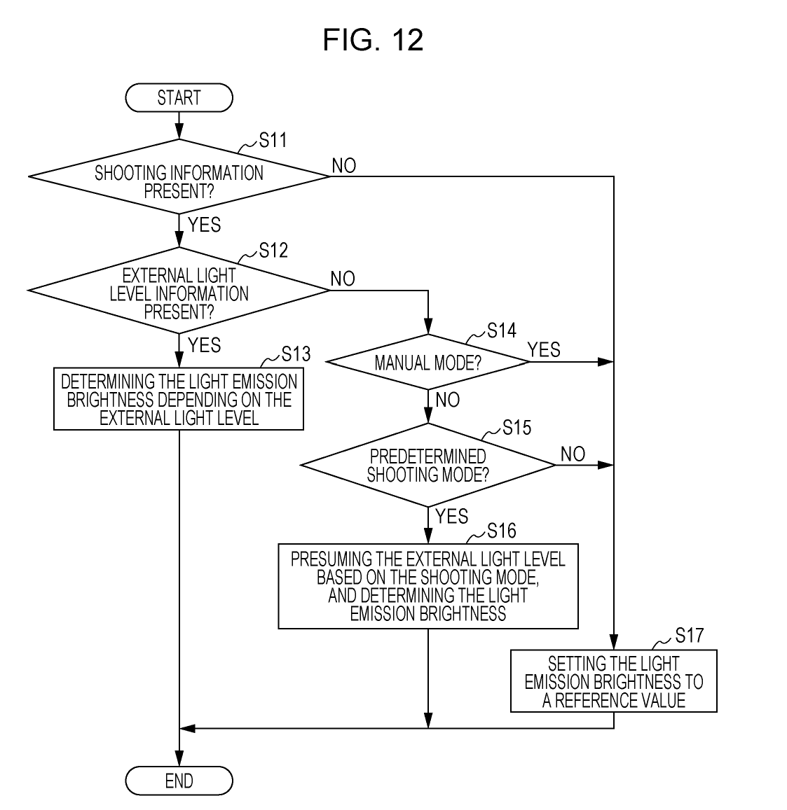

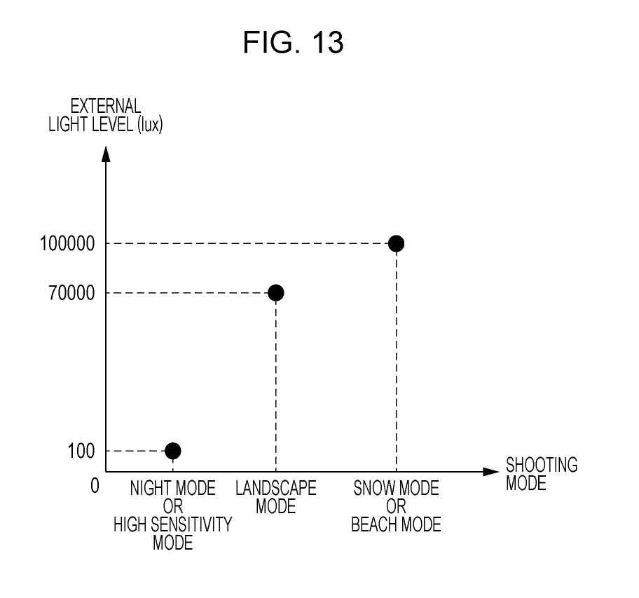

FIG. 12 is an example depiction of a determination processing of the light emission brightness according to an alternative of the first embodiment. Steps S11-S14 and S17 in FIG. 12 are similar to steps S1-S4 and S7 in FIG. 5, and therefore detailed descriptions of steps S11-S14 and S17 are not provided.

If it is determined in step S14 that the image was shot in auto mode, the operation proceeds to step S15, and the emission brightness determining unit 114 determines whether the image was shot with a predetermined shooting mode or not. Specifically, the predetermined shooting mode may include a night mode, high sensitivity mode, landscape mode, snow mode, and beach mode. If it is determined that the image was not shot with the predetermined shooting mode, the operation proceeds to step S17, and the emission brightness determining unit 114 sets the light emission brightness of the light emission unit 116 to a predetermined reference value. On the other hand, if it is determined that the image was shot with the predetermined shooting mode, the operation proceeds to step S16, and the emission brightness determining unit 114 determines the light emission brightness of the light emission unit 116 based on the shooting mode.

FIG. 13 is an example depiction of a relation between shooting mode and external light level (lux). The emission brightness determining unit 114 refers the previously stored table indicating the relation between the shooting mode and the external light level, and estimates the external light level during shooting based on the shooting mode information. The emission brightness determining unit 114 has a memory (not illustrated) that stores the table indicating the relation between the shooting mode and the external light level.

With respect to FIG. 13, if the shooting mode is the night mode or the high sensitivity mode, the external light level is estimated to be 100 lux. If the shooting mode is the landscape mode, the external light level is estimated to be 70,000 lux. If the shooting mode is the snow mode or the beach mode, the external light level is estimated to be 100,000 lux.

Thus, the emission brightness determining unit 114 assumes or estimates the external light level during shooting based on the shooting information, determines the light emission brightness of the light emission unit 116 by referring to the table which indicates the relation between the external light level and the light emission brightness depicted in FIG. 6.

According to the modification of first embodiment, similar effect to the first embodiment can be provided. Further, a calculation processing load can be reduced because a calculation processing for calculating the external light (environmental light) level based on the shutter speed information, aperture value information, and ISO sensitivity information is not necessary in this embodiment. That is because the emission brightness determining unit 114 estimates the external light (environmental light) level during shooting based on the shooting information by referring the table which indicates the relation between the shooting mode and the external light (environmental light) level.

### Second Embodiment

In the above described first embodiment, the light emission brightness of the light emission unit 116 was determined based on the shooting information (external light level, aperture value, shutter speed, ISO sensitivity, shooting mode, etc.). On the other hand, in this second embodiment, the light emission brightness (light emission amount) of the light emission unit 116 is determined based on the shooting information and image characteristic amount information (maximum brightness value, etc.).

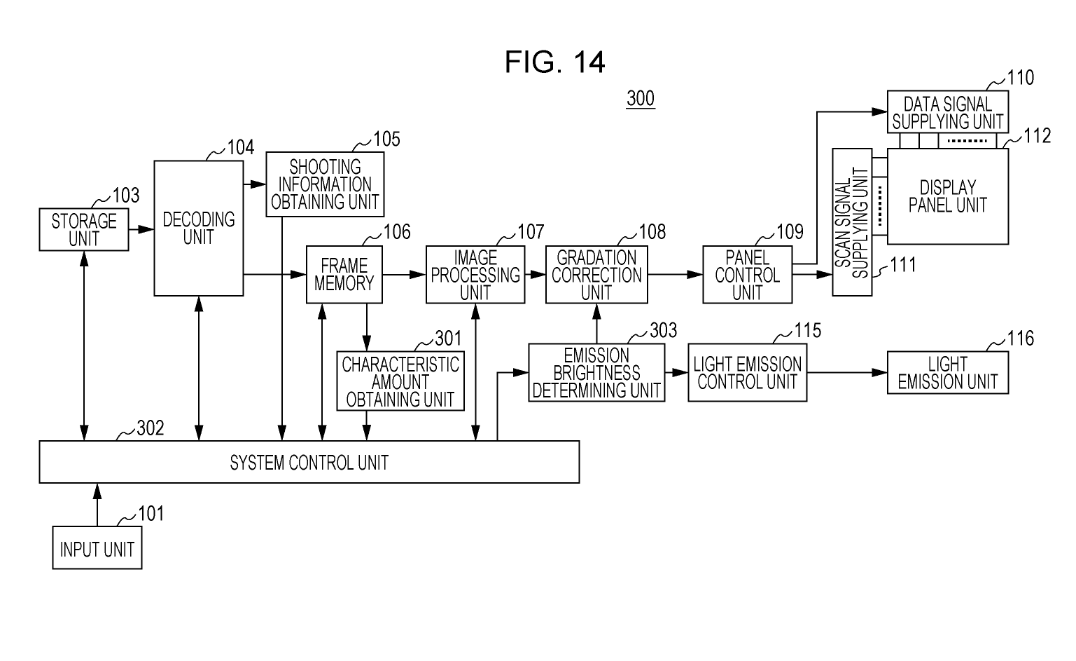

FIG. 14 is an example block diagram that depicts a display apparatus 300 according to this second embodiment. Comparing the display apparatus 300 in FIG. 14 with the display apparatus 100 in FIG. 1, a characteristic amount obtaining unit 301 is added, the system control unit 102 is replaced by a system control unit 302, and the emission brightness determining unit 114 is replaced by an emission brightness determining unit 303. In FIG. 14, the same reference signs are used for components similar to those of FIG. 1, and the details of similar components will not be repeated.

The characteristic amount obtaining unit 301 obtains the image characteristic amount information indicating the image characteristic of each image frame accumulated in the frame memory 106, and outputs the obtained image characteristic amount information to the system control unit 302. Specifically, the characteristic amount obtaining unit 301 analyzes each image frame to generate a brightness histogram, and obtains a maximum brightness value (maximum gradation value) of each image frame. In this embodiment, the characteristic amount obtaining unit 301 obtains the maximum brightness value of each image frame, but the characteristic amount obtaining unit 301 may alternatively obtain an average picture level (APL), etc.

In a similar way to the above described first embodiment, the system control unit 302 controls each function block in the display apparatus 300. Further, the system control unit 302 outputs the image characteristic amount information inputted by the characteristic amount obtaining unit 301 to the emission brightness determining unit 303. Specifically, the system control unit 302 receives the image characteristic amount information corresponding to each image frame, and outputs the received image characteristic amount information to the emission brightness determining unit 303 during the enable-period of the vertical synchronous signal. Thus, image display on the display panel unit 112 and light emission brightness control of the light emission unit 116 are synchronized with respect to each image frame.

The emission brightness determining unit 303 receives the image characteristic amount information obtained by the characteristic amount obtaining unit 301 and the shooting information obtained by the shooting information obtaining unit 105 through the system control unit 302. Then, the emission brightness determining unit 303 determines the light emission brightness of the light emission unit 116 based on the received image characteristic amount information and the shooting information. Specifically, the emission brightness determining unit 303 makes a preliminary determination on the light emission brightness of the light emission unit 116 based on the received image characteristic amount information, then determines an adjusting amount of the light emission brightness, and makes a final determination on the light emission brightness of the light emission unit 116 based on the adjusting amount.

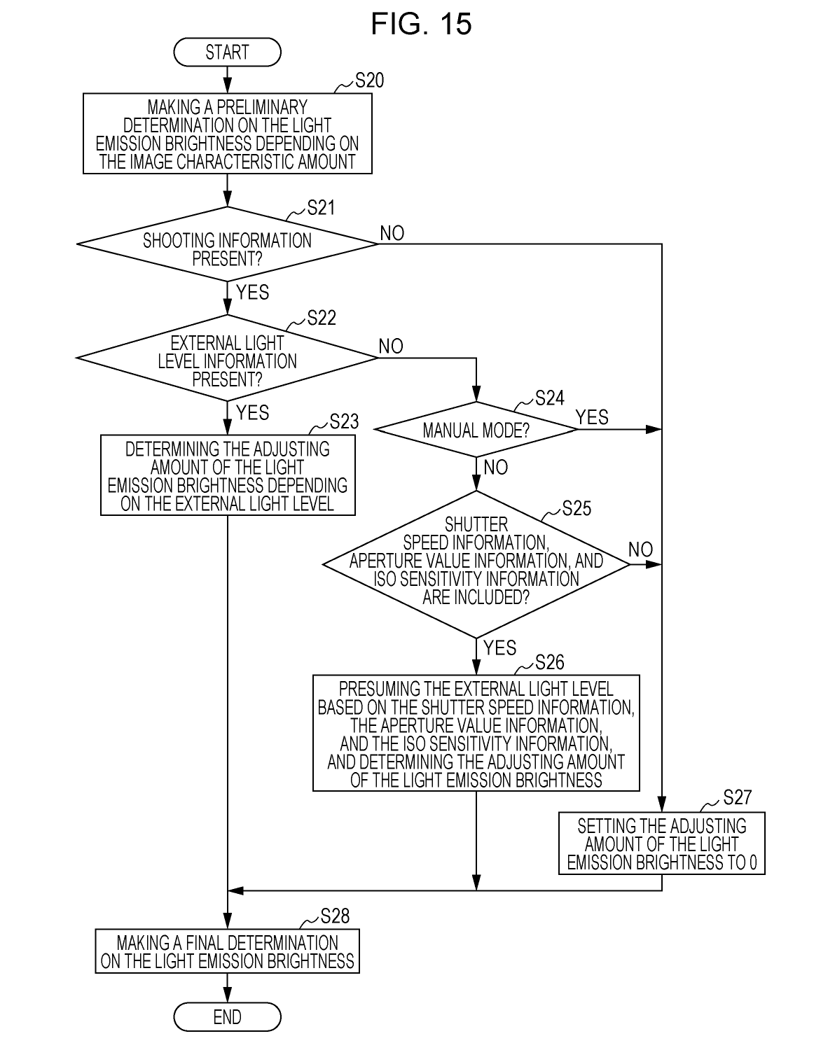

FIG. 15 is an example flow of determination processing of the light emission brightness by the emission brightness determining unit 303. This determination processing of the light emission brightness is executed at the beginning of image display. If the still image is displayed, the emission brightness determining unit 303 executes the determination processing of the light emission brightness before the still image is displayed. If the moving image is displayed, the emission brightness determining unit 303 executes the determination processing of the light emission brightness before the moving image is displayed, and also executes the determination processing of the light emission brightness with respect to each image frame or each scene during the moving image display.

In step S20, the emission brightness determining unit 303 makes a preliminary determination on the light emission brightness of the light emission unit 116 based on the image characteristic amount information obtained by the characteristic amount obtaining unit 301. Specifically, the emission brightness determining unit 303 refers to a previously stored table which indicates a relation between image characteristic amount (maximum brightness value) and light emission brightness, and makes a preliminary determination on the light emission brightness of the light emission unit 116 based on the image characteristic amount (maximum brightness value) of the image data to be displayed. The emission brightness determining unit 303 has a memory (not illustrated) that stores the table indicating the relation between the image characteristic amount (maximum brightness value) and the light emission brightness.

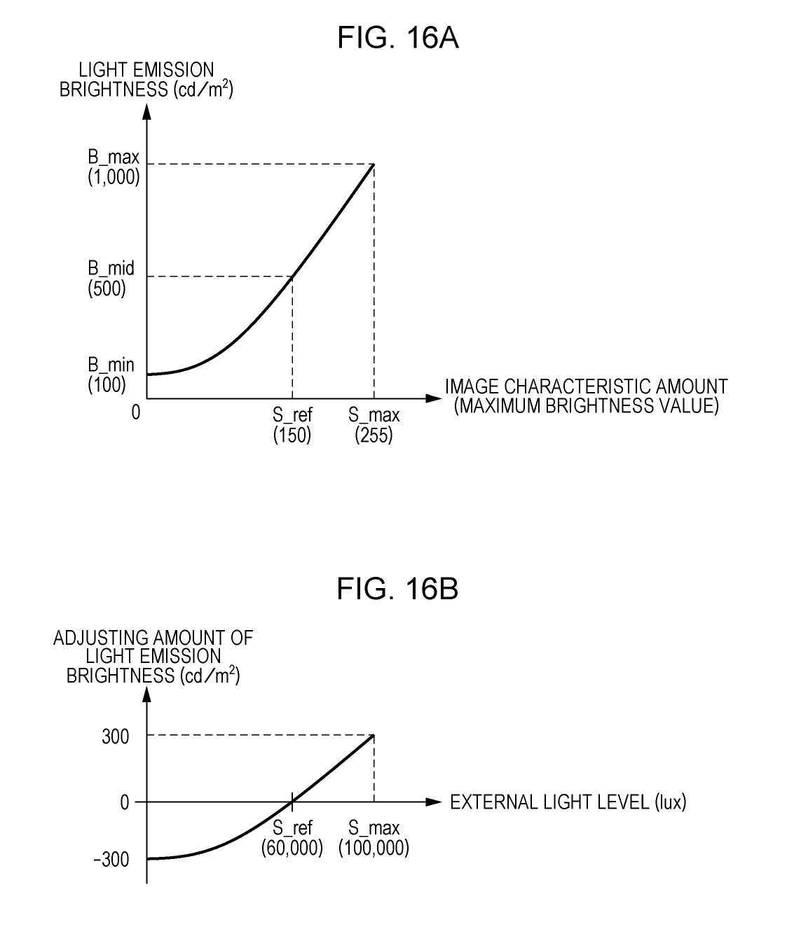

FIG. 16A is an example diagram that depicts a relation between the image characteristic amount and the light emission brightness. In FIG. 16A, the horizontal axis is corresponding to the image characteristic amount (maximum brightness value), and the vertical axis is corresponding to the light emission brightness (cd/m²). The maximum brightness value of 8 bits is example used as the image characteristic amount. In order to realize image display depending on the image characteristic amount such as the brightness of the image data, the light emission brightness is set higher than a reference value if the maximum brightness value of the image data is higher than a predetermined value, and the light emission brightness is set equal to or lower than the reference value if the maximum brightness value of the image data is equal to or lower than the predetermined value. And, the higher the maximum brightness value of the image data is, the higher the light emission brightness is set. The lower the maximum brightness value of the image data is, the lower the light emission brightness is set.

For example, a maximum value B max of the light emission brightness of the light emission unit 116 may be set to 1,000 cd/m² corresponding to a maximum value S_max of the maximum brightness value (for example, 255 cd/m²) of the image data. A medium value B_mid of the light emission brightness of the light emission unit 116 may be set to 500 cd/m² corresponding to the reference value S_ref (for example, 150 cd/m²) of the maximum brightness value of the image data. And for example, a minimum value B_min of the light emission brightness of the light emission unit 116 is set to 100 cd/m² corresponding to black image data. The light emission brightness control depending on the image characteristic amount may be called “dimming control”.

Steps S21, S22, S24, and S25 in FIG. 15 are similar to steps S1, S2, S4, and S5 in FIG. 5. Therefore, detailed descriptions of steps S21, S22, S24, and S25 in FIG. 15 will not be repeated. In step S23, the emission brightness determining unit 303 determines the adjusting amount of the light emission brightness of the light emission unit 116 depending on the external light level by referring to a previously stored table which indicates the relation between the external light level and the adjusting amount of the light emission brightness. The emission brightness determining unit 303 has a memory (not illustrated) that stores the table indicating the relation between the external light level and the adjusting amount of the light emission brightness.

FIG. 16B depicts an example relation between external light level and the adjusting amount of the light emission brightness. In FIG. 16B, the horizontal axis corresponds to the external light level (lux), and the vertical axis corresponds to the adjusting amount of the light emission brightness (cd/m²). In order to realize an image display which is close to the impression of the subject during shooting, the adjusting amount of the light emission brightness is set so as to increase if the external light level is higher than a predetermined value, and the adjusting amount of the light emission brightness is set so as to decrease if the external light level is lower than the predetermined value. Thus, the higher the external light level is, the higher the light emission brightness is set. The lower the external light level is, the lower the light emission brightness is set.

For example, the adjusting amount of the light emission brightness of the light emission unit 116 is set to 300 cd/m² corresponding to a maximum value S_max (for example, 100,000 lux) of the external light level. The adjusting amount of the light emission brightness of the light emission unit 116 is set, for example, to 0 cd/m² corresponding to the reference value S_ref (for example, 60,000 lux) of the external light level. The adjusting amount of the light emission brightness of the light emission unit 116 is set, for example, to −300 cd/m² corresponding to a minimum value S_min (for example 0 lux) of the external light level.

In step S26, the emission brightness determining unit 303 determines the adjusting amount of the light emission brightness of the light emission unit 116 based on the shutter speed information, the aperture value information, and the ISO sensitivity information. Specifically, the emission brightness determining unit 303 estimates the external light level during shooting based on the shutter speed information, the aperture value information, and the ISO sensitivity information. The value EV is calculated as the external light level during shooting by using the numerical formula (1) described above with respect to the first embodiment. Then, the emission brightness determining unit 303 determines the light emission brightness of the light emission unit 116 by referring to the table which indicates the relation between the external light level and the adjusting amount of the light emission brightness illustrated in FIG. 16B.

In step S27, the emission brightness determining unit 303 sets the adjusting amount of the light emission brightness of the light emission unit 116 to 0.

In step S28, the emission brightness determining unit 303 makes a final determination on the light emission brightness of the light emission unit 116 by adding the adjusting amount of the light emission brightness determined in step S23, S26, and S27 to the light emission brightness preliminarily determined in step S20.

Therefore, according to this second embodiment, image display depends on the image characteristic amount by controlling the light emission brightness of the light emission unit of the display apparatus based on the image characteristic amount of the image data. Further, image display which is close to the impression of the subject during shooting is realized by controlling the light emission brightness of the light emission unit of the display apparatus depending on the brightness of the external light (environmental light) during shooting. This embodiment may be especially effective for appreciating a professional still image or a professional moving image because the impression of the subject during shooting can be reproduced more faithfully compared to the conventional technology.

In this embodiment, the light emission brightness of the light emission unit 116 corresponding to all screens is controlled with uniformity, but the light emission brightness of the light emission unit 116 may alternatively be controlled with respect to each divided area. In that case, the emission brightness determining unit 303 may make a preliminary determination on the light emission brightness of the light emission unit 116 with respect to each divided area depending on the image characteristic amount (for example, maximum brightness value) of the image data corresponding to each divided area. Then, the emission brightness determining unit 303 may make a final determination on the light emission brightness of the light emission unit 116 with respect to each divided area by adding the adjusting amount of the light emission brightness determined depending on the shooting information to the preliminarily determined light emission brightness of the light emission unit 116 with respect to each divided area.

Detailed discussion of the gradation correction processing by the gradation correction unit 108 can be omitted, and may be performed in a similar manner as described with respect to the first embodiment above.

The light emission brightness of the light emission unit 116 may be determined based on the shooting mode instead of the shutter speed information, aperture value information, and ISO sensitivity information in a similar manner as in the modification of the first embodiment.

### Third Embodiment

In the above described first and second embodiment, the display apparatus comprises the display panel unit such as liquid crystal display panel unit and the light emission unit (backlight module) is a surface emission device emitting light from behind the display panel unit toward the display panel. In a third embodiment, the display apparatus is a self-emitting type display apparatus.

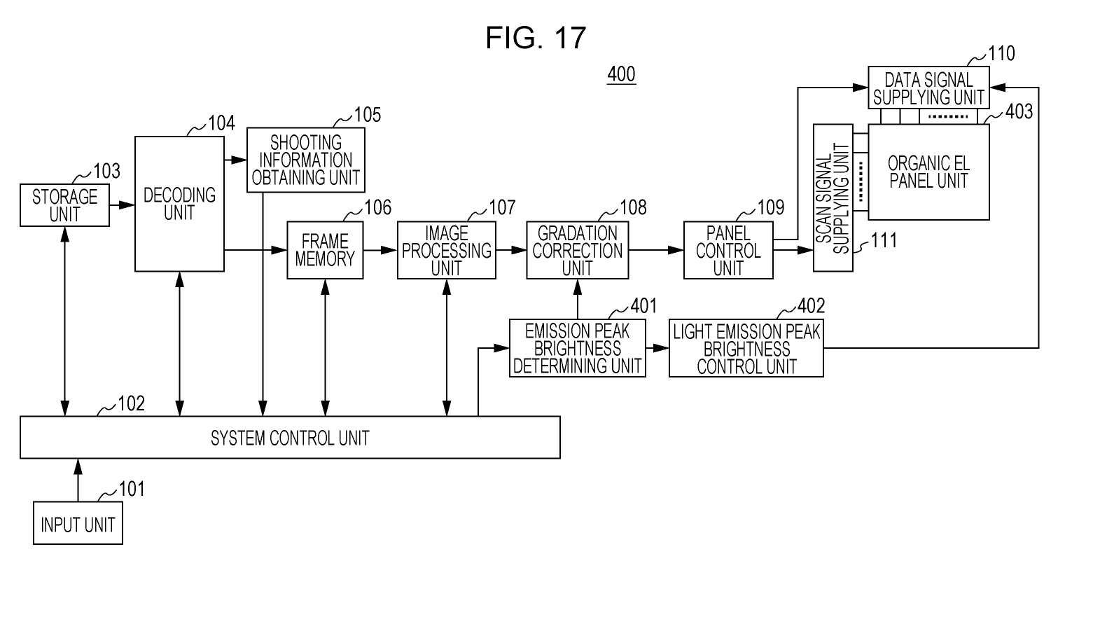

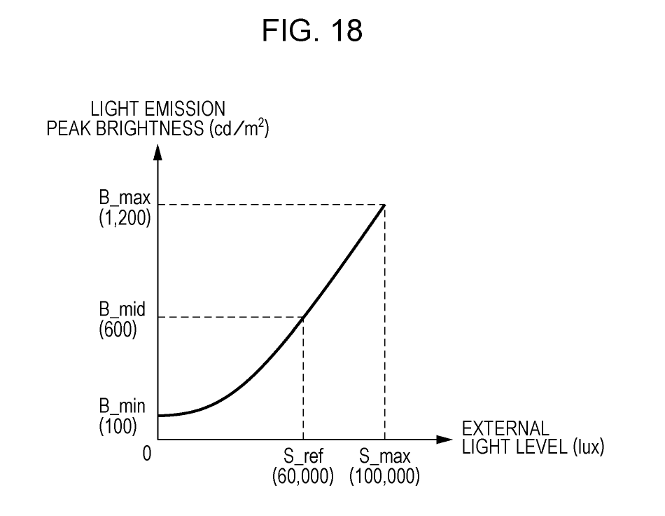

FIG. 17 is an example block diagram that depicts a display apparatus 400 according to a third embodiment. Comparing the display apparatus 400 in FIG. 17 with the display apparatus 100 in FIG. 1, the light emission unit 116 is deleted, the emission brightness determining unit 114 is replaced by an emission peak brightness determining unit 401, the light emission control unit 115 is replaced by a light emission peak brightness control unit 402, and the display panel unit 112 is replaced by an organic Electro Luminescence (EL) panel unit 403. In FIG. 17, the same reference signs as in FIG. 1 are used for components similar to those of FIG. 1, and the details of such components will not be repeated.

The organic EL panel unit 403 has an anode and a cathode corresponding to each EL element. The light emission brightness (light emission amount) of each EL element is determined depending on the current amount from each corresponding anode to cathode. An image is displayed on the organic EL panel 403 by controlling the light emission brightness of each EL element depending on a pixel value (RGB value) of each pixel of an image data. The organic EL panel unit 403 itself operates as a self-emitting type light emission unit.

The emission peak brightness determining unit 401 receives shooting information (external light level, aperture value, shutter speed, ISO sensitivity, shooting mode, etc.) obtained by the shooting information obtaining unit 105 through the system control unit 102. Then, the emission peak brightness determining unit 401 determines the light emission peak brightness (white peak brightness) of the organic EL panel unit 403 based on the received shooting information. The determination processing of the light emission peak brightness by the emission peak brightness determining unit 401 is executed with the same flow illustrated in FIG. 5.

FIG. 18 depicts an example relation between external light level and light emission peak brightness. In FIG. 18, the horizontal axis corresponds to the external light level (lux), and the vertical axis corresponds to the light emission peak brightness (cd/m²). The light emission peak brightness corresponds to a white peak brightness when a white color image is displayed. In order to realize image display which is close to the impression of the subject during shooting, the light emission peak brightness is set higher than a reference value if the external light level is higher than a predetermined value, and the light emission brightness is set equal to or lower than the reference value if the external light level is equal to or lower than the predetermined value. Thus, the higher the external light level is, the higher the light emission peak brightness is set. The lower the external light level is, the lower the light emission peak brightness is set.

For example, a maximum value B max of the light emission peak brightness of the light emission unit 116 is set to 1200 cd/m² corresponding to a maximum value S_max (for example 100,000 lux) of the external light level. A middle value B_mid of the light emission peak brightness of the light emission unit 116 may be set, for example, to 600 cd/m², corresponding to the reference value S_ref (for example 60,000 lux) of the external light level. A minimum value B_min of the light emission peak brightness of the light emission unit 116 may be set, for example, to 100 cd/m² correspondingly to a minimum value S_min (for example 0 lux) of the external light level.

The light emission peak brightness control unit 402 generates a control signal based on the light emission peak brightness determined by the emission peak brightness determining unit 401, and outputs the control signal to the data signal supplying unit 110 and the scan signal supplying unit 111. The scan signal supplying unit 111 selects each scanning line of the organic EL panel unit 403 sequentially based on the scan signal from the panel control unit 109. The data signal supplying unit 110 supplies the image data to each scanning line of the organic EL panel unit 403 based on the line data signal from the panel control unit 109 and the control signal from the light emission peak brightness control unit 402. The light emission peak brightness is controlled by adjusting a current amount of each EL element of the organic EL panel unit 403. For example, the data signal supplying unit 110 controls the current amount of each EL element of the organic EL panel unit 403 by multiplying the line data signal from the panel control unit 109 by a gain coefficient depending on the control signal from the light emission peak brightness control unit 402.

Therefore, according to this third embodiment, an image display which is close to the impression of the subject during shooting is realized by controlling the light emission brightness (light emission peak brightness) of the light emission unit of the display apparatus depending on the brightness of the external light (environmental light) during shooting. This embodiment may be quite effective for appreciating a professional still image or a professional moving image because the impression of the subject during shooting can be reproduced more faithfully in comparison to the conventional technology.

Thus, the higher the external light (environmental light) level is, the higher the light emission peak brightness (white peak brightness) is set, and the wider the dynamic range in which the organic EL panel can be displayed becomes. Black floating does not occur because the black level is not changed, although the total brightness of the image is raised when the external light (environmental light) level is high. Black floating means that black level of an image displayed in higher level than absolutely black level. Additionally, the lower the external light (environmental light) level is, the lower the light emission peak brightness (white peak brightness) is set, and the narrower the dynamic range in which the organic EL panel can be displayed becomes. Thus, the lower the external light (environmental light) level is, the lower the total brightness of the image becomes.

Detailed discussion of the gradation correction processing by the gradation correction unit 108 can be omitted as it is performed in a way similar to that in the first embodiment.

The light emission brightness of the light emission unit 116 may be determined based on the shooting mode instead of the shutter speed information, aperture value information, and ISO sensitivity information in a similar way as in the modification of the first embodiment.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present subject matter has been described with reference to exemplary embodiments, it is to be understood that the subject matter is not limited to the disclosed exemplary embodiments. The scope of the following claims is to be accorded the broadest interpretation so as to encompass all such modifications and equivalent structures and functions.

This application claims the benefit of Japanese Patent Application No. 2013-022397, filed Feb. 7, 2013, which is hereby incorporated by reference herein in its entirety.

What is claimed is:

1. A display apparatus comprising:
a display unit configured to display an image;
a light emission unit configured to emit light to the display unit;
a control unit configured to control the light emission brightness of the light emission unit; and
a gradation correction unit configured to execute gradation correction processing to the image to be displayed by the display unit based on the light emission brightness of the light emission unit.

2. The display apparatus according to claim 1, further comprising:
an obtaining unit configured to obtain shooting information relating to a shooting condition during shooting of the image,
wherein the control unit is configured to control the light emission brightness of the light emission unit based on the shooting information.

3. The display apparatus according to claim 2,
wherein the shooting information includes an external light level information relating to an external light level during shooting of the image, and
wherein the control unit is configured to control the light emission brightness of the light emission unit based on the external light level information.

4. The display apparatus according to claim 2,
wherein the shooting information includes at least one of ISO sensitivity information, shutter speed information, and aperture value information, and
wherein the control unit is configured to control the light emission brightness of the light emission unit based on at least one of ISO sensitivity information, shutter speed information, and aperture value information.

5. The display apparatus according to claim 2,
wherein the shooting information is shooting mode information, and
wherein the control unit is configured to control the light emission brightness of the light emission unit based on the shooting mode information.

6. The display apparatus according to claim 3, wherein the control unit is configured to
in a case that the external light level is higher than a predetermined value, set the light emission brightness of the light emission unit higher than a reference value, and
in a case that the external light level is equal to or lower than the predetermined value, set the light emission brightness equal to or lower than the reference value.

7. The display apparatus according to claim 1, wherein the gradation correction unit is configured to
in a case that the light emission brightness of the light emission unit is higher than a reference value, execute gradation correction processing to the image to be displayed so as to improve a gradation characteristic of a high gradation component of the image, and
in a case that the light emission brightness of the light emission unit is lower than the reference value, improve a gradation characteristic of a low gradation component of the image.

8. The display apparatus according to claim 1, wherein the gradation correction unit is configured to
in a case that the light emission brightness of the light emission unit is higher than a reference value, execute a gradation correction processing to the image to be displayed so as to lower a gradation level of a middle gradation component of the image, and
in a case that the light emission brightness of the light emission unit is lower than the reference value, raise a gradation level of a middle gradation component of the image.

9. The display apparatus according to claim 1, further comprising:
an obtaining unit configured to obtain image characteristic amount information relating to a brightness of the image,
wherein the control unit is configured to control the light emission brightness of the light emission unit based on the image characteristic amount information.

10. A display apparatus comprising:
a self-emitting type display unit configured to display an image;
an obtaining unit configured to obtain shooting information relating to a shooting condition during shooting of the image; and
a control unit configured to control the light emission peak brightness of the light display unit based on the shooting information.

11. A control method of a display apparatus comprising a display unit configured to display an image and a light emission unit configured to emit light to the display unit, the method comprising:
controlling the light emission brightness of the light emission unit; and
executing a gradation correction processing to the image to be displayed by the display unit based on the light emission brightness of the light emission unit.

12. The method according to claim 11, further comprising obtaining shooting information relating to a shooting condition during shooting of the image,
wherein the controlling includes controlling the light emission brightness of the light emission unit based on the shooting information.

13. The method according to claim 12,
wherein the shooting information includes an external light level information relating to an external light level during shooting of the image, and
wherein the controlling includes controlling the light emission brightness of the light emission unit based on the external light level information.

14. The method according to claim 12,
wherein the shooting information includes at least one of ISO sensitivity information, shutter speed information, and aperture value information, and
wherein the controlling includes controlling the light emission brightness of the light emission unit based on at least one of ISO sensitivity information, shutter speed information, and aperture value information.

15. The method according to claim 12,
wherein the shooting information is shooting mode information, and
wherein the controlling includes controlling the light emission brightness of the light emission unit based on the shooting mode information.

16. The method according to claim 13, wherein the controlling includes
in a case that the external light level is higher than a predetermined value, setting the light emission brightness of the light emission unit higher than a reference value, and
in a case that the external light level is equal to or lower than the predetermined value, setting the light emission brightness equal to or lower than the reference value.

17. The method according to claim 11, wherein the executing includes executing gradation correction processing to the image to be displayed so as to
in a case that the light emission brightness of the light emission unit is higher than a reference value, improve a gradation characteristic of a high gradation component of the image and
in a case that the light emission brightness of the light emission unit is lower than the reference value, improve a gradation characteristic of a low gradation component of the image.

18. The method according to claim 11, wherein the executing includes executing a gradation correction processing to the image to be displayed so as to
in a case that the light emission brightness of the light emission unit is higher than a reference value, lower a gradation level of a middle gradation component of the image, and
in a case that the light emission brightness of the light emission unit is lower than the reference value, raise a gradation level of a middle gradation component of the image.

19. The method according to claim 11, further comprising obtaining image characteristic amount information relating to a brightness of the image,
wherein the controlling includes controlling the light emission brightness of the light emission unit based on the image characteristic amount information.

20. A control method of display apparatus comprising a self-emitting type display unit configured to display an image, the method comprising:
obtaining shooting information relating to a shooting condition during shooting of the image; and
controlling the light emission peak brightness of the light display unit based on the shooting information.
